(19) United States
(12) Patent Application Publication
(10) Pub. No.: US 2017/0141994 A1
(43) Pub. Date: May 18, 2017

(54) ANTI-LEECH METHOD AND SYSTEM

(71) Applicants: LE HOLDINGS (BEIJING) CO., LTD., Beijing (CN); LECLOUD COMPUTING CO., LTD., Beijing (CN)

(72) Inventors: Hongfu LI, Beijing (CN); Dongxu HU, Beijing (CN); Ming LI, Beijing (CN)

(73) Assignees: LE HOLDINGS (BEIJING) CO., LTD., Beijing (CN); LECLOUD COMPUTING CO., LTD., Beijing (CN)

(21) Appl. No.: 15/252,363

(22) Filed: Aug. 31, 2016

Related U.S. Application Data
(63) Continuation of application No. PCT/CN2016/083015, filed on May 23, 2016.

(30) Foreign Application Priority Data
Nov. 13, 2015 (CN) 201510781811.4

(51) Int. Cl. H04L 12/26; G06F 17/30; H04L 29/06

(52) U.S. Cl. CPC H04L 43/16; H04L 63/0209; G06F 17/30867; H04L 67/1078

(57) ABSTRACT

Disclosed is a hotlinking protection method and an electronic device. The method includes acquiring characteristic information from access request; generating a digital watermark based on the characteristic information and adding it to the URL of a file to be played to generate a play page address; counting the number of accesses of the play page address having the digital watermark within a certain period; comparing the number of accesses with the predetermined threshold to screen out the play page addresses of which the number of accesses is greater than the predetermined threshold; parsing the digital watermark in the play page addresses to determine IP address of hotlinking user; and shielding the IP address from access service. A more thorough hotlinking protection can be realized and the accuracy of hotlinking protection can be improved.

### CROSS REFERENCE TO RELATED APPLICATIONS

This application is a continuation of International Application No. PCT/CN2016/083015, filed on May 23, 2016, which is based upon and claims priority to Chinese Patent Application No. 201510781811.4, filed on Nov. 13, 2015, the entire contents of which are incorporated herein by reference.

### TECHNICAL FIELD

The disclosure relates to the field of internet security, and particularly to a method for hotlinking protection and an electronic device.

### BACKGROUND

With the rapid development of internet technology and multimedia technology, a large number of security issues have emerged, one of which is hotlinking. Hotlinking refers to that a service provider itself does not offer content of service but offer content of other service providers for end users directly on its own website by using technical means to bypass the end user interface having special benefits (such as advertisement) so as to cheat end user's browsing and click through rate.

In practical use, for example, some unscrupulous businessmen can get the URL (Uniform Resource Locator) address of streaming multimedia files provided by multimedia service provider through using related technologies (such as web crawler), and place it into its own space after modifying some codes of URL address. When a user wants to watch this video, the video can be directly played by user's clicking on this link. However, the real service provider does not know that hotlinking has occurred on their resources, which caused a huge economic loss to the real service provider.

In the process of hotlinking, the beneficiaries do not provide resources or provide just a few resources, but the real service provider do not get any benefits, while bearing a series of hazards caused by hotlinking. For example, site hotlinking will consume a lot of bandwidth of hotlinking site, which result in slower access speed of hotlinking site and smaller real click through rate. Moreover, if there exists a large number of such hotlinking, it may slow down the server, and make network stuck and pause, which will not only lead to a bad experience for uses, but also damage the interests of hotlinking site. More seriously, pornographic or reactionary contents in hotlinking site will bring about a serious influence on the reputation of hotlinking. Therefore, hotlinking protection will be imperative in internet security and especially in wireless internet security.

Currently traditional methods of hotlinking protection include a method for determining a reference address and a method of using dynamic file name. The method for determining a reference address is realized by analyzing the value of Referer field in HTTP header when a browser requests a page so as to determine whether hotlinking is occurred. But the reference address can be easily forged or tampered, thus hotlinking protection cannot be realized thoroughly using such method. In the method of using dynamic file name, a key is obtained by calculation with the program when a user clicks on a download link, then the key and corresponding resource ID or file name are recorded in database or cache, and finally a webpage will redirect to a new URL address which need to include the key. When the browser or download tool sends a request, the program can first verify whether the key exists, and if it exists then corresponding resource data is returned. However, the resource will be in the “resource list of candidates” by some download tools when any one of users successfully download the resource data, so that other people can still download the same file in other place in future as long as the key is effective, thus the hotlinking will continue.

### SUMMARY

In order to solve the problem of an incomplete hotlinking protection, which is caused by the fact that reference address can be easily forged and information of illegal vendors is listed in “resource list of candidates” while using dynamic file name, in one aspect, a method for hotlinking protection is provided according to an embodiment of the present application, which includes:

acquiring characteristic information from an access request, the characteristic information at least including IP address and access time;

generating a digital watermark based on the characteristic information and adding the digital watermark to the URL of a file to be played to generate a play page address;

counting the number of accesses to the play page address having the digital watermark within a certain period;

comparing the number of accesses with the predetermined threshold to screen out the play page addresses that the number of accesses is greater than the predetermined threshold;

parsing the digital watermark in the play page addresses to determine IP address of hotlinking user; and

shielding the IP address from access service.

According to another embodiment of the present application, a method for hotlinking protection is provided, it includes:

acquiring characteristic information from an access request, the characteristic information at least including IP address and access time;

generating a digital watermark based on the characteristic information and adding it to the URL of a file to be played to generate a play page address;

sending a fishing access request to a hotlinking user;

receiving a play page address returned by the hotlinking user;

parsing the digital watermark in the play page address to determine an IP address of the hotlinking user; and

shielding the IP address from access service.

According to another aspect of embodiments of the present application, there is further provided a non-transitory computer-readable storage medium storing executable instructions that used to execute any one of methods of the present application as described above.

According to yet another aspect of the embodiments of the present application, there is further provided an electronic device, the device includes at least one processor and a memory for storing instructions executable by the at least one processor, wherein execution of the instructions by the at least one processor causes the at least one processor to execute any one of methods of the present application as described above.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flow diagram illustrating a method for hotlinking protection according to an embodiment of the present application;

FIG. 2 is a schematic flow diagram illustrating a method for hotlinking protection according to another embodiment of the present application;

FIG. 3 is a schematic diagram illustrating a system for hotlinking protection according to an embodiment of the present application;

FIG. 4 is a schematic diagram illustrating a system for hotlinking protection according to another embodiment of the present application;

FIG. 5 is an architecture diagram to implement the method and system for hotlinking protection of the embodiments of the present application; and

FIG. 6 is a structure diagram of a an electronic device applied to the embodiments of hotlinking protection center of the present application.

### DETAILED DESCRIPTION

In order to make the purpose, technical solutions, and advantages of the embodiments of the application more clearly, technical solutions of the embodiments of the present application will be described clearly and completely in conjunction with the figures. Obviously, the described embodiments are merely part of the embodiments of the present application, but not all embodiments. Based on the embodiments of the present application, other embodiments obtained by the ordinary skill in the art without inventive efforts are within the scope of the present application.

It should be noted that, embodiments of the present application and the technical features involved therein may be combined with each other in case they are not conflict with each other.

The present application can be applied in resource for downloading picture, music, video, software, zip file or the like. For example, the pictures provided by various sites such as Taobao, Paipai, Youa and so on, films dedicated for members provided by media sites such as le.com, Youku, PPTV, Iqiyi and so on and internal files and related resources provided by training institutions such as New Oriental, Universal IELTS and Weibo, etc.

Hardware processor can be used to implement relevant function module of embodiments of the present application.

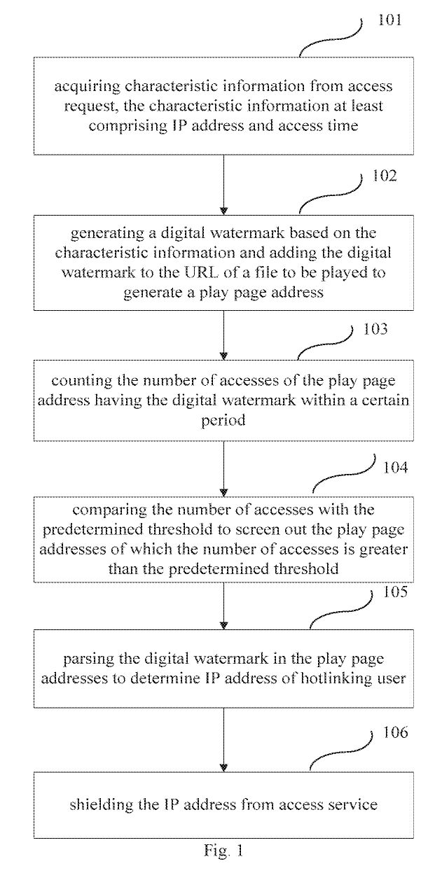

FIG. 1 is a schematic flow diagram illustrating a method for hotlinking protection according to one embodiment of the present application. As shown in FIG. 1, the method for hotlinking protection includes the following steps.

Step S101: acquiring characteristic information from user's access request by a hotlinking protection center, the characteristic information at least including IP address and access time;

Step S102: generating a digital watermark based on the characteristic information and adding it to the URL of a file to be played to generate a play page address by the hotlinking protection center;

Step S103: counting the number of accesses of the play page address having the digital watermark within a certain period by the hotlinking protection center;

Step S104: comparing the number of accesses with the predetermined threshold to screen out the play page addresses of which the number of accesses is greater than the predetermined threshold by the hotlinking protection center;

Step S105: parsing the digital watermark in the play page addresses to determine IP address of a hotlinking user by the hotlinking protection center; and

Step S106: shielding the IP address from access service by the hotlinking protection center.

The predetermined threshold in step 104 is determined by an average number of hotlinking in historical database within a certain period and/or work ability of respondent server.

The predetermined threshold mentioned above can be updated periodically or on demand in order to improve the accuracy of judgment on hotlinking.

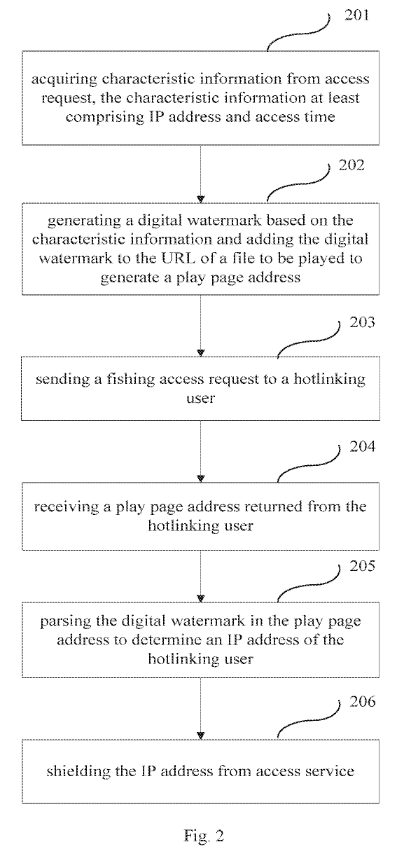

FIG. 2 is a schematic flow diagram illustrating a method for hotlinking protection according to another embodiment of the present application. As shown in FIG. 2, the method for hotlinking protection includes the following steps.

Step S201: acquiring characteristic information from user's access request by a hotlinking protection center, the characteristic information at least including IP address and access time;

Step S202: generating a digital watermark based on the characteristic information and adding it to the URL of a file to be played to generate a play page address by hotlinking protection center;

Step S203: sending a fishing access request to a hotlinking user by hotlinking protection center;

Step S204: receiving a play page address returned by the hotlinking user by hotlinking protection center;

Step S205: parsing the digital watermark in the play page address to determine an IP address of the hotlinking user by hotlinking protection center; and

Step S206: shielding the IP address from access service by hotlinking protection center.

Above characteristic information from access request further includes MAC address, source physical port number and Ethernet protocol type, etc.

The above step of generating a digital watermark based on the characteristic information and adding it to the URL of a file to be played to generate a play page address includes:

processing on at least IP address and access time of the characteristic information to generate a digital watermark using random number generator by hotlinking protection center;

and

adding the digital watermark to the URL of a file to be played to generate a play page address by hotlinking protection center.

Each individual user can have an individual digital watermark information depending on the different characteristic information in access request, such as difference in IP address, access time, MAC address, source physical port number and Ethernet protocol type of accessing user. Moreover, the digital watermark held by the user can be changed according to the different access time of the access request of the same user, and thereby a different play page address will be generated, so that an overlook or error in judgement can be avoided.

In the case that a hotlinking user is determined by hotlinking protection center, hotlinking protection center can access the service (for example, Vst) provided by the hotlinking user through simulating a user to get a play page address of hotlinking user and analyze the digital watermark in the play page address to determine the IP address of hotlinking user, and then report the IP address to server so as to directly shield the IP address from access service.

In practice, for example, now more and more students want to take the postgraduate entrance exam. In order to stand out in the fierce competition, students will download a variety of learning materials. However, because some of the materials are internal reference materials belong to some training institutions (for example, Wendu, New Oriental, Qihang, etc.), these materials can only be downloaded and viewed by the students of the institution. In order to obtain these learning materials, students will browse various learning websites to obtain these learning materials. At this time, some illegal businessmen will steal the download address belonged to training institutions to offer the students so as to make an illegal profit. In order to fight illegal businessmen and safeguard the interests of training institutions, firstly, a digital watermark can be generated based on IP address, access time, student names or the like of the internal student and be added to the URL of access file to generate a play page address. Next, the number of accesses of the play page address having the digital watermark within a certain period can be counted and be compared with the predetermined threshold to screen out the play page addresses that the number of accesses is greater than the predetermined threshold. Finally, the IP address of hotlinking user can be determined by parsing the digital watermark in the play page addresses and be shielded from access service. In such a manner that goal of preventing illegal operators from stealing learning materials can be attained.

Accidental injury during hotlinking protection may occur, for example, the access service of a company Weibo may be shielded by using the method of above-described embodiment though it was authorized to use internal materials by the institution New Oriental. To avoid such accidentally injury, hotlinking protection center can first acquire characteristic information (at least including IP address and access time) from access requests, and generate a digital watermark based on the characteristic information. Hotlinking protection center can add the digital watermark to the URL of a file to be played to generate a play page address and then send a fishing access request to a hotlinking user. After receiving the play page address returned by the hotlinking user, the hotlinking protection center can parse the digital watermark in the play page address to determine an IP address of the hotlinking user so as to shield the IP address from access service. This can effectively prevent accidental injury to authorized user during hotlinking protection.

The present application affects neither the link that a visitor requested, nor the business logic of the site, thus it is easy and convenient to be carried out. The various alternatives of characteristic information which may be used to generate digital watermark sharply reduces the possibility of hotlinking and solves in principle the problems that IP address cannot be distinguished due to accesses of a lot of visitors to a site using the same proxy. The present application has high feasibility, which can be achieved by filters and other simple techniques by most of the sites, and will not affect original business of the site.

The hotlinking protection method according to the present application can not only ensure the normal user's access and restrict the hotlinking user at the same time, but also achieve a more complete hotlinking protection owing to the different digital watermark generated from different characteristic information of accessing user which cannot be easily forged.

Further, the hotlinking protection method according another embodiment of the present application, hotlinking protection center (is a server or server cluster) can send a fishing access request to a hotlinking user, receive a play page address returned by the hotlinking user, parse the digital watermark in the play page address to determine an IP address of the hotlinking user and then shield the IP address from access service, thereby avoiding accidental injury to authorized users of streaming media manufacturers during hotlinking protection and improving the accuracy of the hotlinking protection.

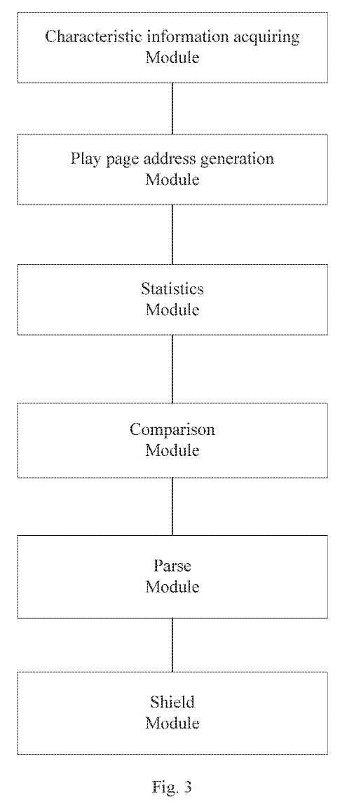

FIG. 3 is a schematic diagram illustrating a system for hotlinking protection according to one embodiment of the present application. As shown in FIG. 3, the system includes:

a characteristic information acquiring module configured to acquire characteristic information from user's access request, the characteristic information at least including IP address and access time;

a play page address generation module configured to generate a digital watermark based on the characteristic information which is acquired by characteristic information acquiring module and add the digital watermark to the URL of a file to be played to generate a play page address;

a statistics module configured to count the number of accesses of the play page address which is generated by play page address generation module having the digital watermark within a certain period;

a comparison module configured to compare the number of accesses which is determined by the statistics module with the predetermined threshold to screen out play page addresses of which the number of accesses is greater than the predetermined threshold;

a parse module configured to parse the digital watermark which is determined by comparison module in the play page addresses to determine an IP address of hotlinking user; and

a shield module configured to shield the IP address which is determined by the parse module from access service.

The predetermined threshold in the above comparison module is determined by an average number of hotlinking in historical database within a certain period and/or work ability of the respondent server.

In this embodiment, the hotlinking protection center of the system for hotlinking protection may be a server or a cluster server, in which each module may be a separate server or cluster server. At this time, interactions of above-mentioned modules are actually interactions of server or cluster server corresponding to each module. Multiple servers or server clusters together constitute the system for hotlinking protection of the present application.

More specifically, the system for hotlinking protection of the present application which is constituted by multiple servers or server clusters together includes:

a characteristic information acquiring server/server cluster configured to acquire characteristic information from user's access request, the characteristic information at least including IP address and access time;

a play page address generation server/server cluster configured to generate a digital watermark based on the characteristic information acquired by the characteristic information acquiring server/server cluster, and adding the digital watermark to the URL of a file to be played to generate a play page address;

a statistics server/server cluster configured to count the number of accesses of the play page address generated by the play page address generation server/server cluster with the digital watermark within a certain period;

a comparison server/server cluster configured to compare the number of accesses determined by the statistics server/server cluster with the size of the predetermined threshold to screen out the play page addresses of which the number of accesses is greater than the predetermined threshold;

a parse server/server cluster configured to parse the digital watermark determined by comparison server/server cluster in the play page addresses to determine IP address of a hotlinking user; and

a shield module configured to shield the IP address determined by parse server/server cluster from access service.

In an alternative embodiment, a few of modules among the above multiple modules may together constitute a server or server cluster. For example, the characteristic information acquiring module and the play page address generation module together constitute a first server or first server cluster, the statistics module and the comparison module together constitute a second server or second server cluster, and the parse module and the shield module together constitute a third server or third server cluster.

In this case, interactions of the above-mentioned modules are actually interactions among the first serve/server cluster to the sixth server/server cluster or among the first server/server cluster to the third server/server cluster. The first servers/server cluster to the sixth servers/server cluster or the first servers/server cluster to the third servers/server cluster together constitute the system for hotlinking protection of the present application.

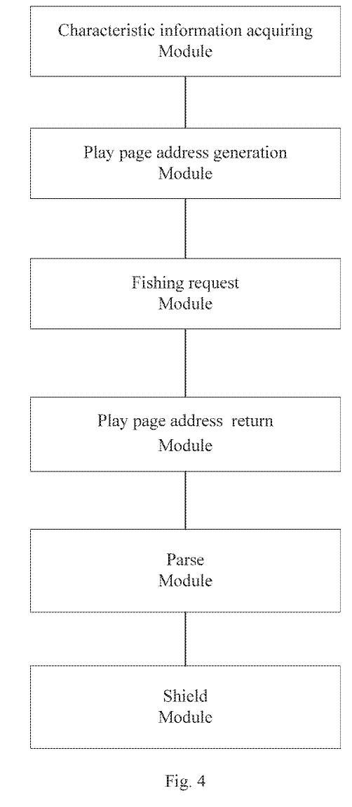

FIG. 4 is a schematic diagram illustrating a system for hotlinking protection according to another embodiment of the present application. As shown in FIG. 4, the system includes:

a characteristic information acquiring module configured to acquire characteristic information from user's access request, the characteristic information at least including IP address and access time;

a play page address generation module configured to generate a digital watermark based on the characteristic information which is acquired by characteristic information acquiring module, and adding the digital watermark to the URL of a file to be played to generate a play page address;

a fishing request module configured to send a fishing access request to a hotlinking user;

a play page address return module configured to receive a play page address returned from the hotlinking user;

a parse module configured to parse the digital watermark in the play page addresses which is returned from the play page address return module to determine IP address of hotlinking user; and

a shield module configured to shield the IP address which is determined by the parse module from access service.

The characteristic information in the access request as described above may further include MAC address, source physical port number and Ethernet protocol type, etc.

The above play page address generation module is configured to generate a digital watermark based on the characteristic information and add the digital watermark to the URL of a file to be played to generate a play page address, including:

processing on at least IP address and access time of the characteristic information to generate a digital watermark using random number generator; and

adding the digital watermark to the URL of a file to be played to generate a play page address.

In this embodiment, the hotlinking protection center of the system for hotlinking protection may be a server or a cluster server, in which each module may be a separate server or cluster server. At this time, interactions of above-mentioned modules are actually interactions of the server or cluster server corresponding to each module. Multiple servers or server clusters together constitute the system for hotlinking protection of the present application.

In this embodiment, detailed implementation of the system for hotlinking protection of the present application which is together constituted by multiple servers/server clusters can refer to above description on the embodiments of system for hotlinking protection and not describe here. The method and system for hotlinking protection by the present application, that can not only ensure the normal user's access and restrict the hotlinking user at the same time, but also achieve a more complete hotlinking protection owing to the different digital watermark generated from different characteristic information of accessing user which cannot be easily forged.

Further, The method and system for hotlinking protection according to another embodiment of the present application can send a fishing access request to a hotlinking user, receive a play page address returned from the hotlinking user, parse the digital watermark in the play page address to determine an IP address of the hotlinking user and then shield the IP address from access service, thereby avoiding accidental injury to authorized users of streaming media manufacturers in hotlinking protection and improving the accuracy of the hotlinking protection.

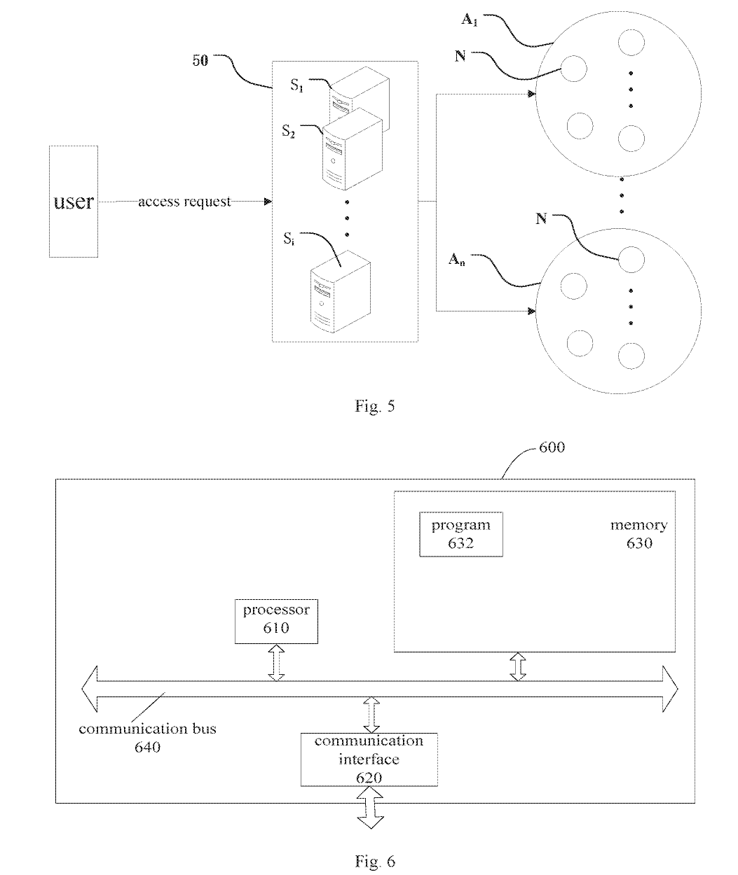

FIG. 5 is an architecture diagram that implements the method and system for hotlinking protection of the embodiments of the present application, which includes a hotlinking protection center 50, and regions A₁ to Aₙ, wherein the hotlinking protection center 50 includes multiple servers (S₁-S₁). Each of the regions A1 to Aₙ includes plurality of margin CDN node N which provides resource service such as streaming media and so on. In this architecture, after receiving the access request sent by a user via a client (at least a smart terminal), servers of the hotlinking protection center can execute the method as shown in FIG. 1. The hotlinking user is restricted while the user can normally access.

An embodiment of the present application also provides a non-transitory computer-readable storage medium storing executable instructions that used to execute any one of methods of the present application as described above.

FIG. 6 is a structure diagram of an electronic device such as a server 600 applied to the embodiments of hotlinking protection center of the present application. The specific implementation of server 600 is not limited in the present application. As shown in FIG. 6, the server includes a processor 610, a communication interface 620, a memory 630 and a communication bus 640.

The processor 610, the communication interface 620 and the memory 630 can communicate with each other via the communication bus 640.

The communication interface 620 can communicate with a network element such as client or the like.

The processor 610 can perform a program stored in memory 630, specifically, it can perform related steps of above embodiments.

Specifically, program 632 may include a program code having a computer operating instruction.

The processor 610 may be a central processing unit (CPU), or a Application Specific Integrated Circuit (ASIC), or one or more integrated circuits configured to implement the embodiments of the present application.

In the server of the above embodiment, The memory 630 can store program 632 which makes the processor to perform the following steps:

acquiring characteristic information from access request, the characteristic information at least including IP address and access time;

generating a digital watermark based on the characteristic information and adding it to the URL of a file to be played to generate a play page address;

counting the number of accesses of the play page address having the digital watermark within a certain period;

comparing the number of accesses with the size of the predetermined threshold to screen out the play page addresses that the number of accesses is greater than the predetermined threshold;

parsing the digital watermark in the play page addresses to determine IP address of hotlinking user; and

shielding the IP address from access service.

or/and to perform the following steps:

acquiring characteristic information from access request, the characteristic information at least including IP address and access time;

generating a digital watermark based on the characteristic information and adding it to the URL of a file to be played to generate a play page address;

sending a fishing access request to a hotlinking user;

receiving a play page address returned by the hotlinking user;

parsing the digital watermark in the play page address to determine an IP address of the hotlinking user; and

shielding the IP address from access service.

The foregoing embodiments of device are merely illustrative, in which those units described as separate parts may or may not be separated physically. Displaying part may or may not be a physical unit, i.e., may locate in one place or distributed in several parts of a network. Some or all modules may be selected according to practical requirement to realize the purpose of the embodiments, and such embodiments can be understood and implemented by the skilled person in the art without inventive effort.

A person skilled in the art can clearly understand from the above description of embodiments that these embodiments can be implemented through software in conjunction with general-purpose hardware, or directly through hardware. Based on such understanding, the essence of foregoing technical solutions, or those features making contribution to the prior art may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof.

Finally, it should be noted that, the above embodiments are merely provided for describing the technical solutions of the present application, but not intended as a limitation. Although the present application has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the present application.

None of the elements recited in the claims are intended to be a means-plus-function element within the meaning of 35 U.S.C. §112(f) unless an element is expressly recited using the phrase “means for,” or in the case of a method claim using the phrases “operation for” or “step for.”

What is claimed is:

1. A method for hotlinking protection comprising, at an electronic device,
acquiring characteristic information from access request, the characteristic information at least comprising IP address and access time;
generating a digital watermark based on the characteristic information and adding the digital watermark to a URL of a file to be played to generate a play page address;
counting the number of accesses of the play page address having the digital watermark within a certain period;
comparing the number of accesses with a predetermined threshold to screen out the play page addresses which the number of accesses is greater than the predetermined threshold;
parsing the digital watermark in the play page addresses to determine IP address of hotlinking user; and
shielding the IP address from access service.

2. The method of claim 1, wherein the predetermined threshold is determined by an average number of hotlinking in historical database within a certain period and/or work ability of respondent server.

3. A method for hotlinking protection comprising, at an electronic device,
acquiring characteristic information from access request, the characteristic information at least comprising IP address and access time;
generating a digital watermark based on the characteristic information and adding the digital watermark to the URL of a file to be played to generate a play page address;
sending a fishing access request to a hotlinking user;
receiving a play page address returned from the hotlinking user;
parsing the digital watermark in the play page address to determine an IP address of the hotlinking user; and
shielding the IP address from access service.

4. The method of claim 3, wherein said generating a digital watermark based on the characteristic information and adding it to the URL of a file to be played to generate a play page address, comprising:
processing on at least IP address and access time in the characteristic information to generate a digital watermark using a random number generator; and
adding the digital watermark to the URL of a file to be played to generate a play page address.

5. The method of claim 4, wherein the characteristic information from access request further includes MAC address, source physical port number and Ethernet protocol type.

6. An electronic device, comprising:
at least one processor; and
a memory communicably connected with the at least one processor for storing instructions executable by the at least one processor, wherein execution of the instructions by the at least one processor causes the at least one processor to:
acquire characteristic information from access request, the characteristic information at least comprising IP address and access time;
generate a digital watermark based on the characteristic information and add the digital watermark to the URL of a file to be played to generate a play page address;
count the number of accesses of the play page address having the digital watermark within a certain period;
compare the number of accesses with the predetermined threshold to screen out the play page addresses which the number of accesses is greater than the predetermined threshold;
parse the digital watermark in the play page addresses to determine IP address of hotlinking user; and
shielding the IP address from access service;

7. The electronic device according to claim 6, wherein the predetermined threshold is determined by an average number of hotlinking in historical database within a certain period and/or work ability of respondent server.

8. The electronic device according to claim 6, wherein execution of the instructions by the at least one processor causes the at least one processor to:
process on at least IP address and access time in the characteristic information to generate a digital watermark using a random number generator; and
add the digital watermark to the URL of a file to be played to generate a play page address.

9. The electronic device according to claim 8, wherein the characteristic information from access request further includes MAC address, source physical port number and Ethernet protocol type.
